(19) United States
(12) Patent Application Publication
(10) Pub. No.: US 2018/0231312 A1
(43) Pub. Date: Aug. 16, 2018

(54) METHODS OF THERMAL PROCESSING

(71) Applicant: GeoRoc International, Inc., Chevy Chase, MD (US)

(72) Inventors: Salvatore MORICCA, New South Wales (AU); Simon Chung, New South Wales (AU); Bruno Salvatore Angelico, Dandenong (AU); Eric Stephens, Dandenong (AU); Martin William Alexander Stewart, New South Wales (AU)

(73) Assignee: GeoRoc International, Inc., Chevy Chase, MD (US)

(21) Appl. No.: 15/896,343

(22) Filed: Feb. 14, 2018

Related U.S. Application Data
(60) Provisional application No. 62/458,668, filed on Feb. 14, 2017.

(51) Int. Cl. F27B 9/14; F27B 9/16; C10B 7/04; C10B 1/04; B01J 6/00; F27B 9/40; C21D 9/00; B09B 3/00; G21F 9/32; F27D 17/00

(52) U.S. Cl. CPC F27B 9/142; F27B 9/16; C10B 7/04; C10B 1/04; B01J 6/004; F27D 2019/0006; C21D 9/005; B09B 3/0083; G21F 9/32; F27D 17/00; F27B 9/40

(57) ABSTRACT

There is disclosed a vertical vibratory thermal treatment system, comprising a heating section for thermally treating material, a retort section that is located within or connected to the heating section and includes at least one elevator system for vertically moving the material to the heating section. The disclosed elevator system is isolated from other parts of the thermal treatment section by an enclosure thereby allowing for flexibility and simplicity in the design of the retort section. There is also disclosed a method of treating materials, including hazardous or radioactive materials, such as a powder, sand, granule, gravel, agglomerate or other form of particle or combinations thereof, using the system described herein.

This application claims the benefit of priority to U.S. Provisional Application No. 62/458,668, filed Feb. 14, 2017, which is incorporated herein by reference in its entirety.

### DESCRIPTION

### Technical Field

There is disclosed a vertical vibratory calciner and a method of using the same to thermally process powder materials. There are also disclosed methods of using a vertical vibratory calciner to treat hazardous waste, such as nuclear waste, including in remote environments.

### Background

Calcination is typically defined as the heating of a substance below the melting or fusing point, which will cause a loss of moisture, reduction or oxidation, and the decomposition of compounds, such as carbonates. More relevant to the present disclosure, calcination can be used to convert liquid material, including radioactive wastes, to granular solids by drying at very high temperatures.

Calcination is typically carried out in rotary calciners, fluidized beds, or static beds. In the thermal treatment of hazardous materials, it is desirable to use such calciners in remote environments. In such remote operations, gas flows can be introduced to control the conditions in the calciner retort, or the part of the system that transmits the hazardous material through the calciner. There could also be an off-gas system designed to remove any volatiles and dust that may be carried over.

Calciner systems used in current hot-cell designs for treating radioactive wastes have several limitations. Rotary calciner systems have several inherent problems that render their use in hot cells more complex: rotary seals wear and leak and therefore need periodic replacement; the replacement process involves a break in the containment and subsequent spread of contamination; leaking seals are a contamination leakage risk and can lead to air ingress that is problematic for some radioactive waste chemistries; the rotary action creates tumbling of the powder and increases dust carryover; and the radioactive wastes treated often become sticky when dried and calcined. The latter, can cause the powder bed to build-up and requires the use of a rabble bar to break up any “cake” that may form on the walls, this bar in turn will increase dusting and complicate the off-gas system. Furthermore, the powder travels by gravity down the tube. Hence variations in particulate size or shape or roughness can change the rate at which different particles travel down the tube leading to segregation or at worst “rat running”. It is therefore difficult in some situations to guarantee that all particles have seen the same temperature profile, or have been fully heat treated or calcined. The latter can be problematic for some downstream processes.

Fluidized beds have limitations of temperature use, have a large footprint and because of the large volumes of gas needed for fluidization require large off-gas treatment systems. In addition, fluidized beds can be difficult to maintain at a uniform temperature. Problems with existing calciners lie in the construction methods being complicated and expensive. In addition, existing systems do not allow for use in remote locations.

To solve the many needs described above, and overcome the mentioned deficiencies, Applicants have developed a vertical vibratory thermal treatment system, which may be described as a vertical vibratory calciner. Applicants have also developed a method that uses the vertical vibratory calciner to thermally treat particular type materials, including radioactive and hazardous materials in remote locations.

### SUMMARY

There is disclosed a vertical vibratory thermal treatment system, comprising a heating section for thermally treating particulate containing material; a retort section that is located within the heating section and includes at least one elevator system for vertically moving the material to the heating section, wherein the elevator system is isolated from other parts of the thermal treatment section by an enclosure. In one embodiment, the disclosed system comprises at least one vibratory motor that transmits the material located in the retort section to the heating section.

There is also disclosed a method of treating particulate materials, including hazardous materials, such as a radioactive powder, sand, granule, gravel, agglomerate or other form of particle or combinations thereof, using the system described herein.

In an embodiment, there is disclosed a method of thermally treating a particulate material, comprising introducing through at least one inlet a particulate containing material into a retort section of a vertical vibratory thermal treatment system; vertically transporting the material through the retort section using at least one elevator system; thermally treating the material in a heating section; cooling the material in a section of the retort that is located outside of the heating section; and removing the treated material through at least one outlet.

### DETAILED DESCRIPTION OF THE DRAWING

The accompanying drawings, which are incorporated in and constitute a part of this specification, illustrate disclosed embodiments and, together with the description, serve to explain the disclosed embodiments. In the drawings:

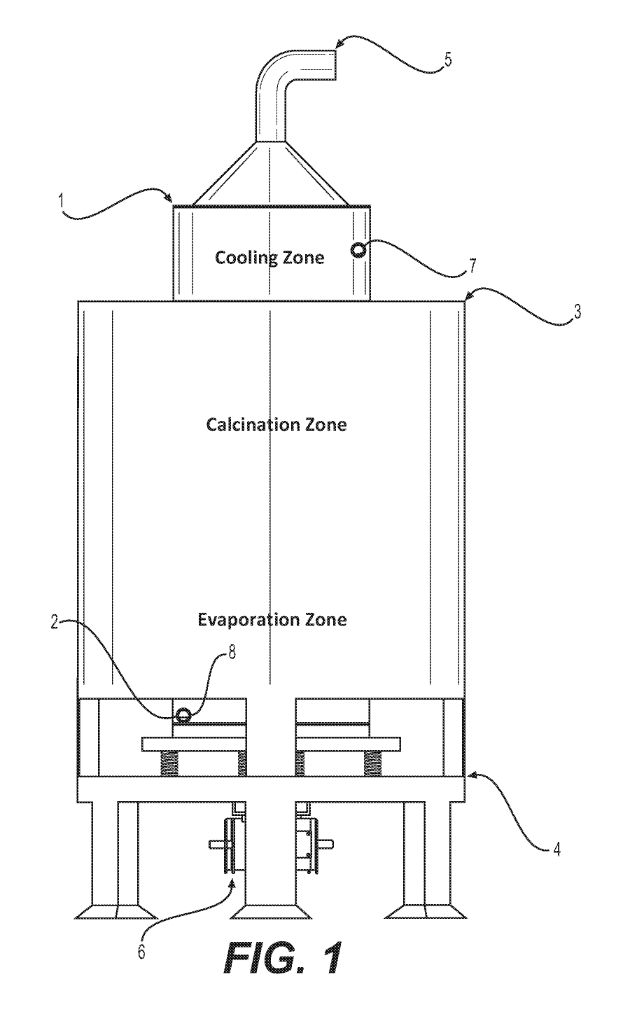

FIG. 1 is an outer perspective of vertical vibratory thermal treatment system, including heating elements and insulation, according to the present disclosure.

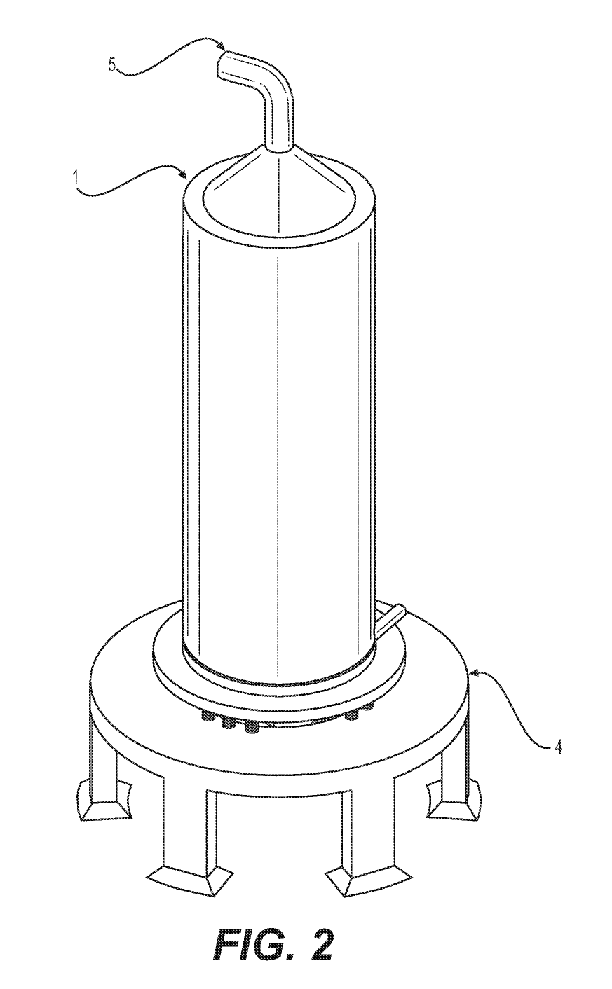

FIG. 2 is an outer perspective of a retort within the system of FIG. 1, without the heating elements and insulation surrounding it.

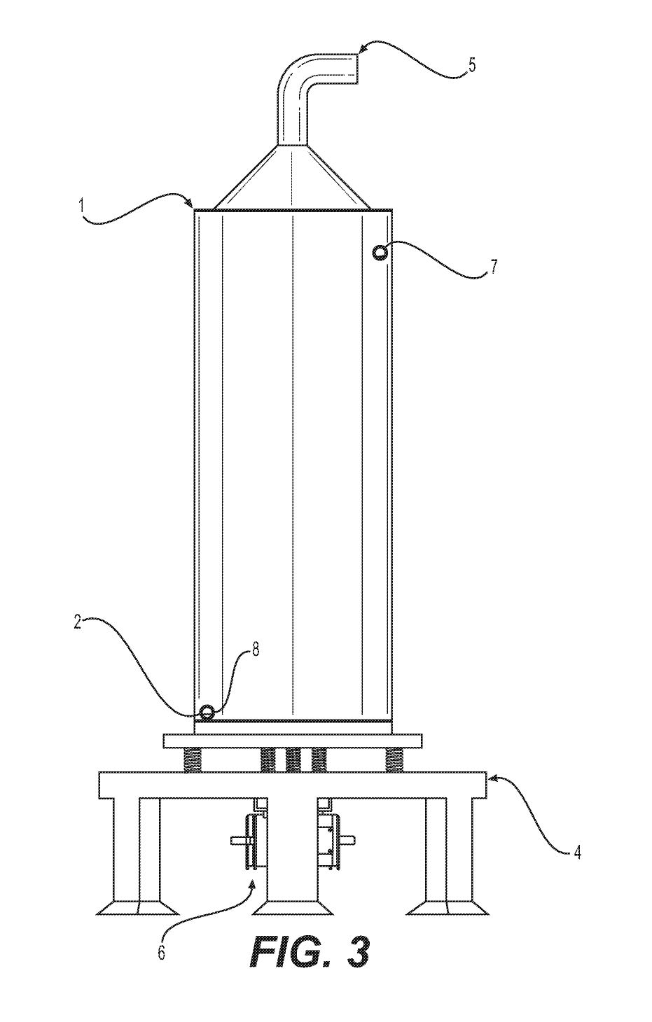

FIG. 3 is another perspective of the retort shown in FIG. 2.

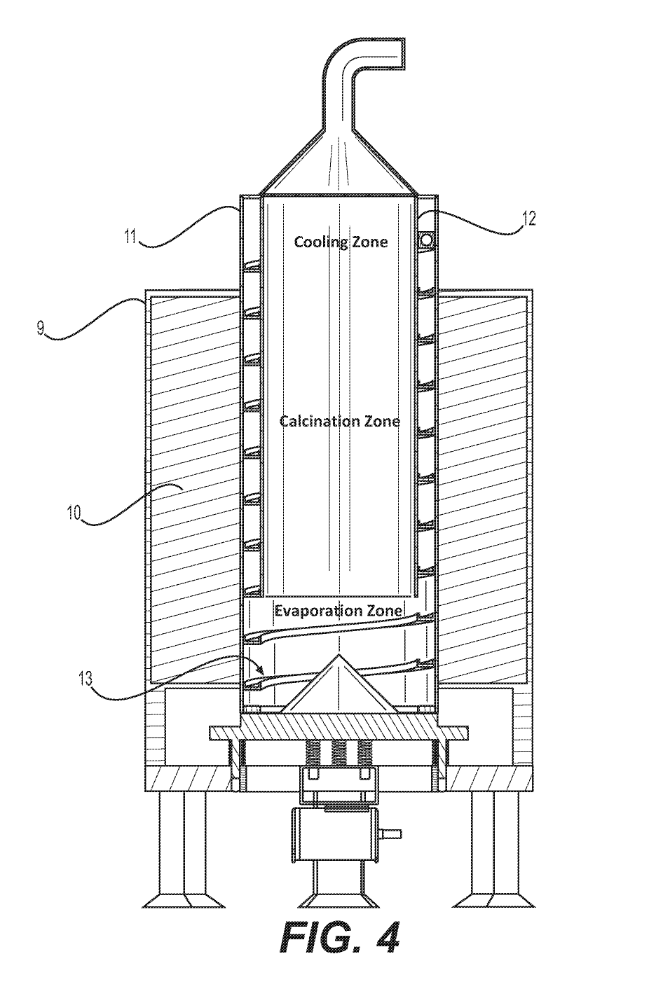

FIG. 4 is a cross-sectional perspective showing the interior of the vertical vibratory thermal treatment system of FIG. 1.

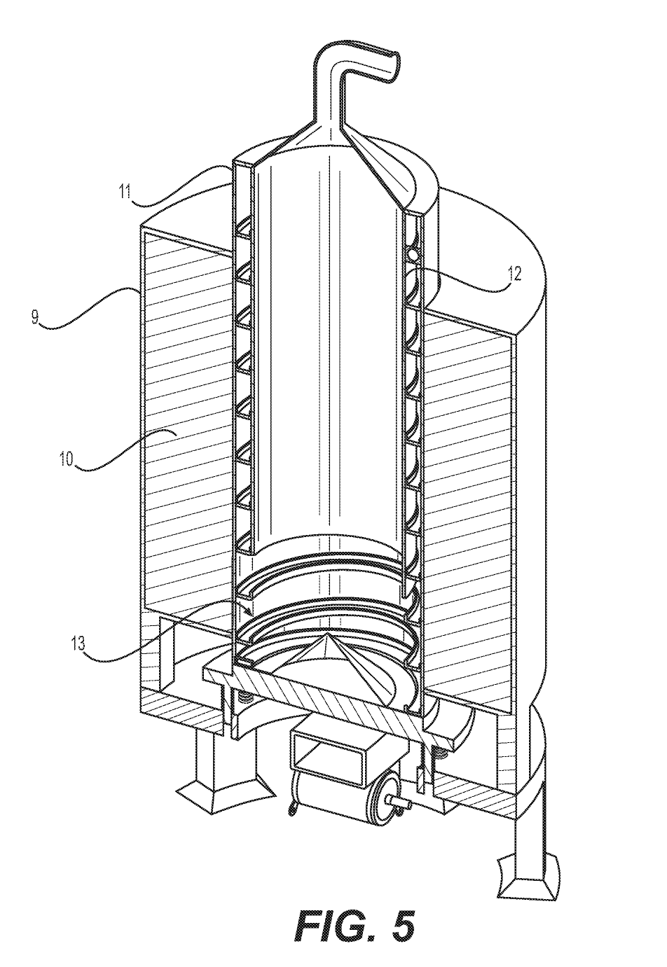

FIG. 5 is another perspective of the cross-sectional perspective of the vertical vibratory thermal treatment system of FIG. 4.

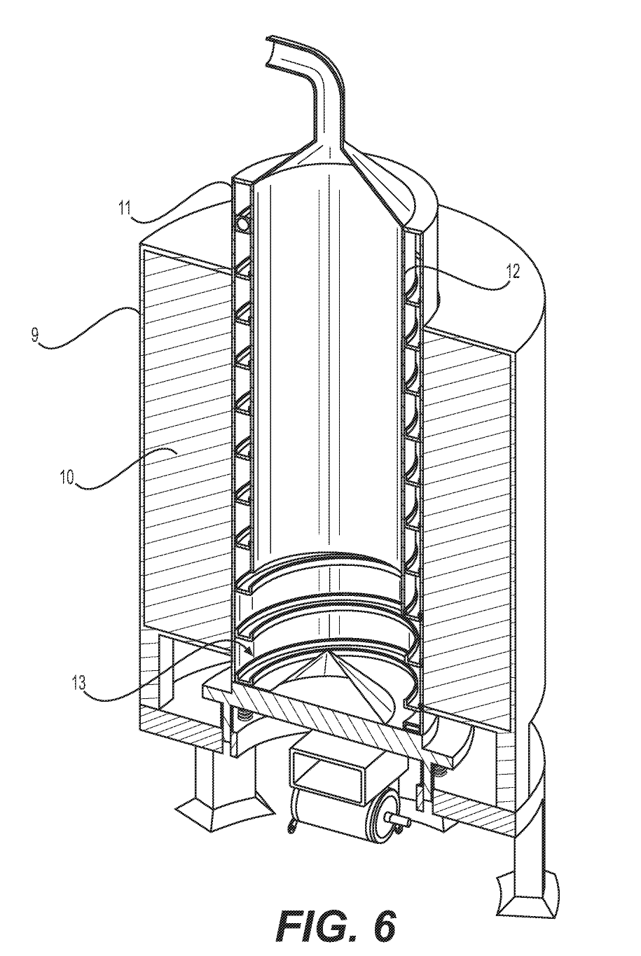

FIG. 6 is another perspective of the cross-sectional perspective of the vertical vibratory thermal treatment system of FIG. 4.

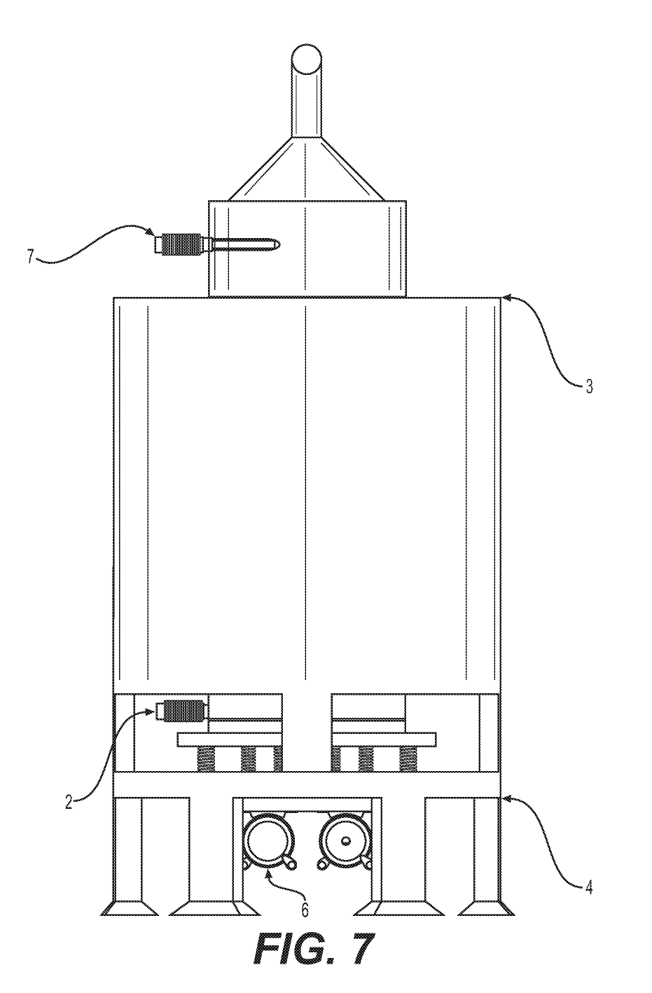

FIG. 7 is a schematic of a vertical vibratory thermal treatment system of FIG. 1, showing side perspectives of the inlet of outlet.

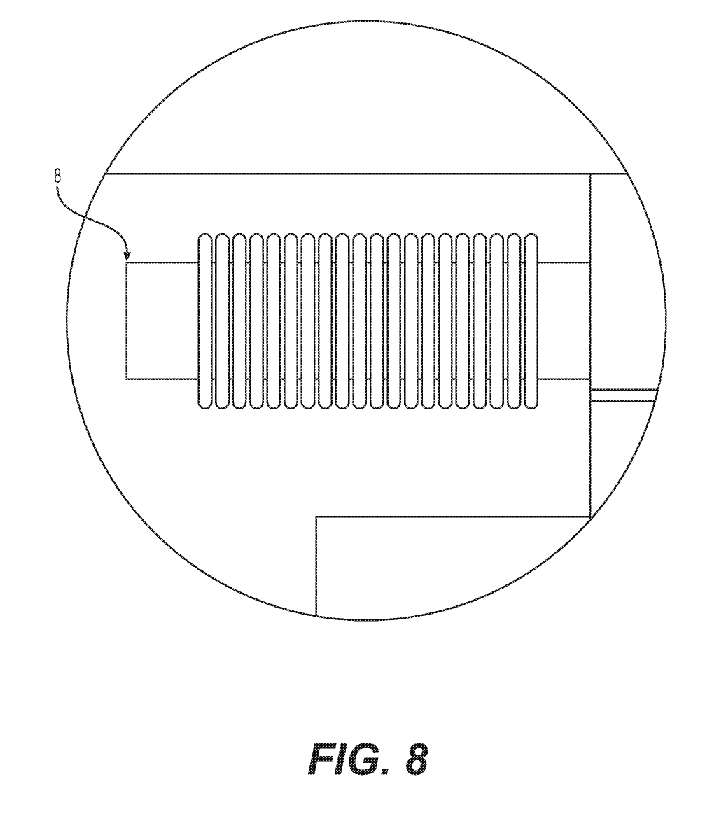

FIG. 8 is an enlarged perspective of the flexible coupling shown in FIG. 1 at (8).

It is to be understood that both the foregoing general description and the following detailed description are exemplary and explanatory only and are not restrictive of the invention, as claimed.

### DETAILED DESCRIPTION OF THE INVENTION

Described herein is a vibratory calciner which uses a spiral elevator thermal heat treatment system. In the described system, the material is moved up or down the calciner by means of a spiral elevator, or tube-like system attached to the calciner retort body. Movement is typically provided by tuned vibrations that moves the material up or down the spiral and hence through the calciner.

In one embodiment, there is disclosed a vibratory calciner with unique features that enable its use in remote environments. Such features include a retort, or a chamber within which materials is held, comprising spiral elevator that is fixed inside the tube, which is much more difficult to manufacture, but allows for operations in which the material to be processed should be enclosed/isolated form the surrounding environment. The spiral elevator is described as a series of flights that overcome possible manufacturing difficulties, such as a small diameter of the tube or stresses induced in the continuous spiral that can lead to weld failure or distortion at high temperatures. The unique design of the disclosed retort has a number of advantages, including a simplification of manufacturing, improvement of operability, and the enablement of more complex shapes/setups of the retort itself, as well as the flights of the elevator. The new design also enables the use of alternate materials to traditional steel alloys, and reduces construction time and cost.

In one embodiment, to avoid complicated manufacturing, the retort designs are limited to simple cylindrical shapes. However, it is appreciated that more complex shaped retorts, such as cones, hour glass shapes, double cones, etc., can be made according to the present disclosure.

With reference to the Figures, there is disclosed a system comprising a retort (1) through which the material to be heat treated travels. This retort is heated, and typically contained within an insulated furnace (3), both of which sit on a support frame (4). The insulated furnace contains a furnace shell (9), which contains heating elements and insulation (10). In an embodiment, the retort comprises an outer containment wall (11) and an inner containment wall (12).

In an embodiment, the retort contains an elevator system, also referred to as a “flight” either in the form of a spiral-like trough/chute or tube of various shapes, such as round, rectangular, square, and oval, through which the material to be heat treated travels (13). In an embodiment, the spiral-like trough/chute or tube is located between the outer containment wall (11) and an inner containment wall (12).

Movement of the particular material to be treated may be achieved by vibratory motors attached to the system (6). These motors are set to enable the material to be processed to move up or down the retort. Speed and other parameters can also be varied such that the material sees a programmed temperature-time profile. The material to be processed can be a powder, sand, granule, gravel, agglomerate or other form of particle or can be a part of component. These materials may be found in dry, semi-dry, or a viscous state, such as a wet mud or a similar viscous mixture of liquid and solid components. As used herein, “semi-dry” means the material contains some liquid, such as water, but which still flows as a powder or an agglomerated powder, and that may need to be dried prior to it being further treated in the retort.

In one embodiment, the retort (1) may be heated by a variety of means such as resistance heating elements, induction heating, infra-red heating or microwave heating, all of which may be contained with the furnace shell (9). In such embodiments, the retort (1) is connected to or located within a furnace/oven/calciner (3). The temperature profile across the retort and the rate of movement are controlled, as is the atmospheric and pressure conditions in the retort. This enables materials to be thermally treated, calcined, or processed in a controlled manner As shown in FIGS. 1 and 4, the retort can have distinct sections for the thermal treatment of particulate material. For example, going from bottom to top, the retort can have an evaporation zone to dry the material prior to it being transferred to the calcining zone. After calcining, the material can be transferred to the cooling zone, prior to its release from the outlet (7).

In addition to the system described herein, there are described methods of using these systems, including design features to improve the operations of the described system. The system described herein extend the life of the system and the operating limits of the equipment, such that they may be used at higher temperatures or in more extreme physical and chemical environments. In addition, there is described features of the system that enable the operation and maintenance of the systems remotely rendering them useful for operations in hazardous conditions, such as radioactive hot-cells. By allowing the disclosed system to operate remotely, it can operate through a wall, such as a Hot Cell, with no human intervention.

There methods of using the vibratory calciner in a variety of applications include but are not limited to heat treating materials or components or parts using the vibratory calciner described herein.

In another embodiment, there is described a method of calcining materials, such as to remove undesirable components using the vibratory calciner described herein.

In another embodiment, there is described a method of drying of materials and components using the vibratory calciner described herein.

In another embodiment, there is described a method of controlling reaction synthesis of materials using the vibratory calciner described herein.

In another embodiment, there is described a method of thermally granulating of materials using the vibratory calciner described herein.

In another embodiment, there is described a method annealing materials using the vibratory calciner described herein.

In another embodiment, there is described a method of causing materials reaction using the vibratory calciner described herein.

In another embodiment, there is described a method of sintering materials, such as granules, grits, aggregates or other particles, to produce an aggregated product using the vibratory calciner described herein.

In another embodiment, there is described a method of applying a surface coating or reaction of materials or components using the vibratory calciner described herein.

In another embodiment, there is described a method of nitriding materials or components using the vibratory calciner described herein.

In another embodiment, there is described a method of reaction synthesis with various materials using the vibratory calciner described herein.

In another embodiment, there is described a method of preheating materials using the vibratory calciner described herein prior to additional thermal treatment steps.

In another embodiment, there is described a method of controlled cooling of materials using the vibratory calciner described herein.

In various embodiments, the typical materials of construction for the vertical vibratory thermal treatment system described herein includes a metal or alloy of steel, stainless steel, titanium, nickel, chromium, or combinations thereof. In various embodiments, the metal or alloy comprises stainless steel, austenitic nickel-chromium-based super alloys, Ti 6Al-4V, and combinations thereof.

In one embodiment, the calciner comprises special alloys, such as ternary carbides, referred to as “Ternary Carbide Alloys” that are stable up to and including at operating temperatures of 1200° C.

In various embodiments, the chute/trough/tube or flights can range from 20 to 300 mm wide depending on diameter of the retort, although they can be larger for very large systems. The chutes can be of varying shape including curved, straight, angled. The chute may or may not contain a lip to contain the powder. The angle of the chute to the retort may also act to contain the powder. The chute/trough/tube or flights can be manufactured using a variety of processes including 3D printing to make net shape components. The chute/trough/tube flights may be continuous or sectioned.

In various embodiments, flights can be attached to the retort by welding of rolled, pressed or otherwise shaped sections. Alternatively, casting, powder metallurgy sintering, 3D printing or machining from a block may be used to form the flight-retort section.

In one embodiment, the vertical vibratory calciner disclosed herein may alternatively have the trough/chutes as a series of flights to form a spiral stairway like structure with steps between each level over which the processed material cascades to reach the next flight. This alternative to the invention differs from previous retort models, which have continuous in that the chute section has been broken up into stages with “waterfalls” between each stage (flight). Each stage is approximately ⅛ to four circumferential lengths. This enables easy access for welding of each section inside the calciner retort tube and simplifies construction. The inventors are unaware of any non-continuous spiral calciners, as described herein.

The use of chute segments/flights also enables the construction of more complex geometries such as cone, double cone, hourglass or other shaped retorts, which can be advantageous in terms of decreasing calciner gas flow rates and dusting or varying heat treatment profiles or the degree of vibration to which the feed is subjected.

The “waterfalls” between each chute section also provide a number of advantages, including improving particulate mixing with the process gas. The waterfalls also serve to mix the powder bed itself.

In one embodiment, the design of the system is such that it contains at least one diverter valve at the materials exit from the retort to enable recirculation of the flow and hence recycling of materials. This recycling is important in some instances in maintaining continuous operational flow of materials to prevent sintering of sticking. In one embodiment, the retort itself can be one piece with a design life equal or greater than that required by a plant.

The retort can alternatively be capable of being split. In this case, it is held together by springs, pins, bolts or other means enabling easy dismantling and removal of the retort. This retort option is segmented and modularized to enable easy removal of the top and or bottom.

In one embodiment, chute/flight sections may be coated to provide a layer of coating material that improves chute performance. For example, coating layers can be applied to chute/flight sections to increase wear resistance, chemical resistance, reducing sticking, and the like.

In one embodiment, the calciner troughs/flute/tube flights may have sections coated with a material to prevent sticking, decrease erosion, or eliminate static charge. In one embodiment, the segments of the calciner may be coated with a catalytic material that enhances reactions occurring during the treatment process.

In one embodiment, the system contains a furnace that heats the retort. For example, heating may be performed by resistance elements. The resistance heating elements can be made of ternary carbides, such as e.g. Ti₂AlC. These ternary carbides are also referred to as “MAX phase material,” which are known for high temperature application in specialist environments. There is the alternative of using induction heating to heat the retort or materials being processed.

In one embodiment, there is described the alternative of using microwave heating to heat the retort and/or the material being processed within.

In another embodiment, there is described the alternative of using infra-red radiation sources to heat the retort and/or the material being processed within.

In one embodiment, there is described a furnace that has a split shell arrangement with half or less segments that are attached together by bolts, pins, clips or other securing methods, to enable easy dismantling of the furnace from the retort shell. This enables easy replacement of furnace elements and it also enables the easy removal of the retort section from the machine.

Alternatively, the furnace can have a clam shell arrangement that opens up to allow retort removal or element maintenance. The elements are arranged in banks such that they form heating zones enabling a temperature profile through the calciner. For example, the elements are grouped and modularized to enable easy replacement of “banks” of elements”. The elements are grouped in pairs or more such that if one series fails the other may take over and heat the same furnace zone.

In one embodiment, heating may be directly applied to the flights in the retort by attaching heating elements directly to the flights. In an embodiment, the retort can be isolated from the furnace body by sliding or other seals to prevent vibration of the furnace. These seals may be bellows type, flexible hose or sliding seals. Connections are designed for remote release to enable the retort to be disconnected and removed from the system.

In one embodiment, the system is designed to use insulation and other cooling means to minimize the heat output into the operations room, or hot cell.

In various embodiments, parts, powders or granules that couple with the inductive, electric, magnetic field may be added to the material being processed to enable heating.

The system can be adjusted to vary the speed of flow of the materials through the retort. The system is designed to provide a failsafe residence time to completely heat treat the material being processed. For example, the design is such that there is a maximum mass flow rate. This is tailored for different types of materials.

Drive motors may drive the retort vibration and hence the movement of material in the system and these motors may be located on the top or bottom of the system retort. The drive motors can be attached directly to the system or isolated from the system by a drive shaft. The drive motors are in pairs and may be backed up by additional motors located on the same drive system for the retort. The drive motors or shafts can be attached to the top or bottom of the system. The drive motors can be external to the system, i.e., the motors can be isolated from the room (or cell) in which the calciner is placed. The machine is designed such that the vibrating motors give a “soft start” with little jerking, uneven vibration or large movement.

In one embodiment, the system may have backup air powered or other powered motors as backups in case of failure. The system may be driven by air or gas motors if necessary. The vibration is monitored to determine if operation is within normal parameters. This can be used to feedback to emergency controls to stop the system.

The treatment system can be designed to operate under, atmospheric pressure, under vacuum or above atmospheric pressure depending on the needs of the materials being processed. The process gas flow is typically counter-current for decomposition or calcination processes, but may be co-current or counter-current for other applications, depending on the need. The intake and out-take lines including any process gas or other feed lines is isolated from the retort vibration by flexible coupling.

In one embodiment, the described system may contain an off-gas system (5). An off-gas system may include baffles/deflecting plates to separate particulates/dust from the gas stream; one or more cyclones; blowback filters to filter and recycle dust. These may be used individually or in series if one or more is used.

In one embodiment, there is described the devices and methods of injecting gases or liquids into the system. Non-limiting examples of these devices and methods include, but are not limited to: direct gas injection along the stairs/flights; gas injection through the base of the stairs; gas injection trough nozzles or filters in the stairs; steam injection into the system; special process gas injection into the system; and injection of acidic gas/liquid for decomposition of salts, such as carbonates. These may be introduced either at the intake for the gas at the top of the calciner, into the feed bed of the material before it travels through the calciner, or at an engineered point in the calciner.

In one embodiment, there is described an intake to introduce cleaning media to scour/clean the retort system. This media is separated and removed via a screening system incorporated into the system design. Alternatively, the media may be incorporated into the product exiting of the vibratory thermal treatment system.

The flights or sections of the flights can be perforated to separate different sized materials, such as powder from the agglomerates, lumps, cleaning materials, tramp metals, or other lumps.

In one embodiment, the calciner/heat treatment system may be split into two or more stages. For example, one stage can be used for water removal and the following stage for treatment using a process gas. The stages can be connected for counter current gas flow or isolated such that each has an independent or near independent gas flow. Such a design enables the parameters of each stage, such as residence time, atmosphere, pressure, heating profile to be independent of each other. In one embodiment, the two-stage system comprises two systems connected together in series, such as two smaller systems but with the flexibility of running different conditions.

In one embodiment, the retort can contain a hopper section that contains the material to be processed. The material to be processed is introduced into the retort through and inlet gate/valve. The material to be processed can be introduced continuously or as a batch. In one embodiment, whether added in a continuous or batch process, the material may be introduced into a feed or inlet port (2). In an embodiment, and exemplified in FIG. 8, the feed comprises a flexible coupling (8).

Other embodiments of the invention will be apparent to those skilled in the art from consideration of the specification and practice of the invention disclosed herein. It is intended that the specification and examples be considered as exemplary only, with the true scope of the invention being indicated by the following claims.

What is claimed is:

1. A vertical vibratory thermal treatment system, comprising:
a heating section for thermally treating particulate containing material;
a retort section that is connected to or located within the heating section and includes at least one elevator system for vertically moving the material to the heating section; and
at least one vibratory motor that transmits the material located in the retort section to the heating section.

2. The vertical vibratory thermal treatment system of claim 1, wherein the retort section is located within an insulated furnace shell.

3. The vertical vibratory thermal treatment system of claim 1, further comprising at least one inlet located at the bottom of the retort for introducing material to be processed and at least one outlet located at the top of the retort for removing the material that was processed from the retort section.

4. The vertical vibratory thermal treatment system of claim 3, further comprising at least one diverter valve located at the outlet.

5. The vertical vibratory thermal treatment system of claim 4, wherein the at least one diverter valve assists in the recirculation of materials within the retort.

6. The vertical vibratory thermal treatment system of claim 1, wherein the material to be processed comprises a powder, sand, granule, gravel, agglomerate or other form of particle or combinations thereof.

7. The vertical vibratory thermal treatment system of claim 1, wherein the material to be processed comprises a hazardous material, or at least one radioactive isotope.

8. The vertical vibratory thermal treatment system of claim 1, wherein the elevator system for vertically moving material into said heating section is isolated from other parts of the thermal treatment section by an enclosure, and comprises a series of spiral flights or chute within a tube.

9. The vertical vibratory thermal treatment system of claim 1, wherein the elevator system comprises a non-continuous spiral configuration.

10. The vertical vibratory thermal treatment system of claim 9, wherein the non-continuous spiral configuration comprises more than one levels with a step between each level, wherein said step causes the processed material to cascade there-over.

11. The vertical vibratory thermal treatment system of claim 10, wherein the each level ranges from approximately 1/8 to 4 circumferential lengths.

12. The vertical vibratory thermal treatment system of claim 1, wherein the retort has a shape chosen from a cone, double cone, or hourglass.

13. The vertical vibratory thermal treatment system of claim 1, wherein the heating section for thermally treating particulate containing material comprises at least one heating element for drying the material to be treated, for preheating the material to be treated prior to calcining, for calcining the material, or any combination thereof.

14. The vertical vibratory thermal treatment system of claim 13, wherein at least one heating element provides resistance heating, induction heating, infra-red heating or microwave heating.

15. The vertical vibratory thermal treatment system of claim 1, wherein the heating section for thermally treating particulate containing material further comprises at least one controller to control the temperature profile across the retort system.

16. The vertical vibratory thermal treatment system of claim 15, wherein the at least one controller controls the rate of material movement through the retort system.

17. The vertical vibratory thermal treatment system of claim 15, wherein the at least one controller controls the atmospheric and pressure conditions in the retort system.

18. The vertical vibratory thermal treatment system of claim 1, wherein the retort section comprises two or more sections for thermally treating the particulate material.

19. The vertical vibratory thermal treatment system of claim 18, wherein the retort section comprises at least one first section for removing water from the particulate material and at least one second section for treating the material using a process gas.

20. The vertical vibratory thermal treatment system of claim 19, wherein the at least one first and second sections are connected for counter current gas flow.

21. The vertical vibratory thermal treatment system of claim 19, wherein the at least one first and second sections are isolated and each has an independent gas flow.

22. The vertical vibratory thermal treatment system of claim 21, wherein the conditions of at least one first and second section are independent of each other, said conditions comprising residence time of said particulate material, the atmosphere, pressure, heating profile of the sections, or any combination thereof.

23. The vertical vibratory thermal treatment system of claim 18, wherein the two or more sections are connected together in series.

24. The vertical vibratory thermal treatment system of claim 1, further comprising a hopper section that contains the material to be processed.

25. The vertical vibratory thermal treatment system of claim 1, further comprising an off-gas system for removing unwanted gases from the retort.

26. The vertical vibratory thermal treatment system of claim 25, wherein the off-gas system comprises one or more of the following: baffles and/or deflecting plates; cyclones; filters or combinations thereof that may be used individually or in series when used in combination.

27. The vertical vibratory thermal treatment system of claim 26, wherein the off-gas system further comprises at least one device for injecting gases or liquids into the system to help in treating the off-gas.

28. A method of thermally treating a particulate material, comprising:
introducing through at least one inlet a particulate containing material into a retort section of a vertical vibratory thermal treatment system;
vertically transporting said material through the retort section using at least one elevator system;
thermally treating the material in a heating section;
cooling the material in a section of the retort that is located outside of the heating section; and
removing the treated material through at least one outlet.

29. The method of claim 28, wherein the particulate containing material is vertically transported through the retort section by at least one vibratory motor.

30. The method of claim 28, wherein the particulate containing material introduced into the retort comprises powder, sand, granule, gravel, agglomerate or other form of particle or combinations thereof.

31. The method of claim 28, wherein the particulate material is introduced into the retort by at least one inlet located at the bottom of the retort.

32. The method of claim 28, wherein the particulate material is introduced into the retort continuously or as a batch.

33. The method of claim 28, wherein the particulate material is removed from the retort by at least one outlet located at the top of the retort.

34. The method of claim 28, wherein thermally treating a particulate material comprises one or more of the following processes: pre-heating, annealing, calcining, sintering, drying, controlled reaction synthesis, surface coating, nitriding, gas reaction synthesis, and controlled cooling.

35. The method of claim 28, further comprising recirculating the particulate material in the retort by having it impinge on at least one diverter valve located at the at least one outlet.

36. The method of claim 28, wherein the particulate material is vertically moved to the heating section through a non-continuous spiral configuration.

37. The method of claim 36, wherein vertically moving the particulate material to the heating section comprises transporting the material to more than one level with a step between each level to allow the particulate material to cascade there-over.

38. The method of claim 28, wherein thermally treating the material in a heating section heating section comprises operating at least one controller to control at least one of the following: the temperature profile across the retort system, the rate of material movement through the retort system, the atmosphere, and the pressure conditions in the retort system.

39. The method of claim 28, wherein thermally treating the material in a heating section comprises heating the material by resistance heating, induction heating, infra-red heating, microwave heating, or combinations thereof.

40. The method of claim 28, further comprising treating off gas in an off-gas system by passing said off-gas through one or more of the following: baffles and/or deflecting plates; cyclones; filters or combinations thereof.

41. The method of claim 40, wherein treating the off-gas system further comprises injecting gases or liquids into the off-gas system by a method chosen from direct gas injection along the stairs/flights; gas injection through the base of the stairs; gas injection trough nozzles or filters in the stairs; steam injection into the system; special process gas injection into the system; injection of acidic gas/liquid for decomposition of salts, or combinations thereof.

42. The method of claim 41, wherein injecting gases or liquids into the off-gas system comprises introducing said gases or liquids at the intake for the gas, at the top of the calciner, into the feed bed of the material before it travels through the calciner, or combinations thereof.

43. The method of claim 28, wherein the powdered or particulate material that is treated comprises a hazardous or a radioactive material.

44. The method of claim 28, wherein the method is operated remotely.
